(19) United States
(12) Patent Application Publication
(10) Pub. No.: US 2016/0314490 A1
(43) Pub. Date: Oct. 27, 2016

(54) METHOD AND APPARATUS FOR DYNAMICALLY ALTERING ADVERTISING

(71) Applicant: Drive-On-In, Inc., Las Vegas, NV (US)

(72) Inventors: Kipp Sherer, Las Vegas, NV (US); Jennifer Janish, Cupertino, CA (US)

(21) Appl. No.: 15/137,836

(22) Filed: Apr. 25, 2016

Related U.S. Application Data
(60) Provisional application No. 62/152,862, filed on Apr. 25, 2015.

(51) Int. Cl. G06Q 30/02

(52) U.S. Cl. CPC G06Q 30/0244; G06Q 30/0277; G06Q 30/0269

(57) ABSTRACT

A method and apparatus for dynamically adding, or otherwise incorporating, one or more cues, particular to a specific target, into messages, such as advertising messages, directed to the particular target, based upon information known by the advertiser and learned by the advertising provider from prior responses by the specific target, to tailor or otherwise customize the specific message delivered to the specific target.

### CROSS-REFERENCE TO RELATED APPLICATION

This application claims the benefit of U.S. Provisional Application Ser. No. 62/152,862, filed on Apr. 25, 2015, the entirety of which is incorporated herein by reference.

### TECHNICAL FIELD

This application relates to a method and apparatus for dynamically altering advertising presented to a target viewer based upon learned responses by the target viewer.

### BACKGROUND OF THE INVENTION

Advertising may be designed to deliver information, or content, to an audience, and the content may be intended to influence behavior of the audience, such as in influencing purchasing decisions, voting decisions, or the like.

The advertising may be delivered to an audience at large, or it may be delivered to a targeted audience. As the size of the targeted audience becomes smaller, the content of the advertising can be better directed to preferences of those in the audience, such as by making the advertising more personalized.

Targeted advertising may include sensory “cues,” visual, audible or the like. Cues may be a signal of something, or a reminder of something, which may bring to one's mind, such as a recipient of the targeted advertising, something from past knowledge or previous experience that provides a framework of meaning to elicit a favorable impression or emotion. An advertiser may incorporate cues into advertising for various reasons, such as to elicit a favorable response by the recipient.

Current advertising technologies seek to optimize efficiency by targeting, i.e., narrowing the audience to which an advertisement is presented. This narrowing can be done on a variety of factors, including demographics, location, previous searches and interests, or behaviors such as “previously visited web site, but did not purchase.” This differs from applicants' technology, which seeks to broaden a potential audience, rather than narrow it. For instance, conventional targeting would prevent an advertisement for an attorney from showing in a particular zip because previously not many people converted from that area. With applicants' method and apparatus, the ad instead may be progressively altered to be more effective, rather than just not shown. Applicants' technology does not seek to eliminate a potential customer, but rather to dynamically alter the advertisement to be more effective with the potential customer. In certain circumstances, conventional targeting may also be complimentary and used in conjunction with applicants' method and apparatus to eliminate people having no need for a product or service.

Another conventional method of optimizing advertising may appear similar, but which is distinctly different, is optimization performed by advertising networks. This may be accomplished by selecting the most effective advertisements and displaying ones that are more likely to be profitable. This is performed to a level of an individual, but does not alter the advertisements and does not increase the effectiveness of any of the advertisements. In the present case, applicants' technology may not eliminate Company A's advertisement in favor of Company B's advertisement because it is more likely to be effective, rather applicants' technology would alter Company A's ad to be more effective. To the average person seeing the advertisements, this can appear on the surface to be ads tailored to them, since the ad may be for a product for which they just searched.

Psychographic segmentation may also sound similar, but is different. This involves segmenting ad targets into groups based on personality, lifestyle, opinions, etc. This allows targeting and optimization of which advertisements to present to the target such as presenting advertising for baby food to new mothers. This takes an opposite approach from applicants' technology, presenting an advertisement to people most likely to buy that product, rather than creating an ad to the potential target most likely to make them comply.

Another method currently in use that may also appear similar on the surface, but which is distinctly different, is known as creative optimizing. Here a number of variations for an advertisement may be created, and then statistically, or with machine learning, the most effective one is determined. Applicants' technology differs in that the creative is altered on a per target basis, not optimized generically to the entire audience. Applicants' technology also applies specific psychological strategies, again on an individual bases. Not using specific strategies to change the cues makes current creative optimizing unable to be performed to the level of a specific target because many ad views are required by the target to adjust a creative and it would have to be done for each individual, for each ad. Applicants' technology may be applied without many previous views of a particular ad to the target.

### SUMMARY OF THE DISCLOSURE

In accordance with the present invention, a method for enhancing content of a message to be presented to a target via a web accessible presentation device is disclosed. The method may comprise creating a first electronic message, collecting electronic data regarding the target to create an electronic database of target data, creating an electronic first cue for incorporation into the first message, the first cue being tailored to elicit an intended response from the target based upon the collected target data, and electronically altering the first message by incorporating the first cue into the first message.

The method may further comprise electronically delivering the altered first message via the web to the target, determining an actual response by the target to the altered first message, such response indicating a level of effectiveness of the altered first message to elicit the intended response from the target, utilizing the determined actual response as a first indicator of the level of effectiveness of the first cue, electronically storing the first indicator of the level of effectiveness of the first cue in the database, and utilizing the collected target data and the stored indicator of the level of effectiveness of the first cue when creating subsequent cues for subsequent messages to be delivered to the target.

In accordance with another aspect of the present invention, a method for enhancing content of message sequentially presented to a target via a web accessible presentation device is disclosed. The method may comprise creating a first electronic message, collecting electronic data regarding the target to create an electronic database of target data, creating an electronic first cue for incorporation into the first message, the first cue being tailored to elicit an intended response from the target based upon the collected target data, electronically altering the first message by incorporating the first cue into the first message, and electronically delivering the altered first message via the web to the target.

The method may further comprise determining an actual response by the target to the altered first message, such response indicating a level of effectiveness of the altered first message to elicit the intended response from the target, utilizing the determined response as a first indicator of the level of effectiveness of the first cue, and electronically storing the first indicator of the level of effectiveness of the first cue in the target database.

The method may further comprise electronically creating a second message, electronically creating a second cue for incorporation into the second message, the second cue being tailored to elicit an intended second response from the target based upon the collected target data and the indicator of the effectiveness of the first cue, electronically altering the second message by incorporating the second cue into the second message, electronically delivering the altered second message via the web to the target, determining an actual response by the target to the altered second message, such response indicating a level of effectiveness of the altered second message to elicit the intended second response from the target, utilizing the determined response as an indicator of the level of effectiveness of the second cue, storing the second indicator of the level of effectiveness of the second cue in the database, and utilizing the collected target data and the indicators of the levels of effectiveness of the first cue and the second cue when creating a subsequent cue for a subsequent message to be presented to the target.

It is contemplated the second message may include the first and the second cues.

It is further contemplated the message is created in response to a request to a network ad server.

It is still further contemplated the electronic database of target data includes a database of individuals considered to be trusted by the target.

It is still further contemplated The method of claim 2 wherein the electronic database of target data includes a database of animals considered to be trusted by the target.

It is still further contemplated the electronic database of target data includes a database of inanimate objects considered to be trusted by the target.

It is still further contemplated the electronic database of target data includes a database of branded logos considered to be trusted by the target.

It is still further contemplated the electronic database of target data includes a database of colors considered to be preferred by the target.

It is still further contemplated the electronic database of target data includes a database of prior favorable cues.

In accordance with a further aspect of the invention, a system for enhancing content of messages sequentially presented to a target via a web accessible presentation device is disclosed. The system comprises a network ad server communicatively coupled to the web for creating a first electronic message, a data storage device communicatively coupled to the network ad server, collected electronic data regarding the target comprising an electronic database of target data, the target data being stored on the data storage device, an electronic creative ad optimizer for creating an electronic first cue for incorporation into the first message, the first cue being tailored to elicit an intended response from the target based upon the collected electronic target data.

The network ad server electronically alters the first message by incorporating the first cue into the first message, electronically delivers the altered first message via the web to the target, determines an actual response by the target to the altered first message, such response indicating a level of effectiveness of the altered first message to elicit the intended response from the target, utilizes the determined response as a first indicator of the level of effectiveness of the first cue; electronically stores the first indicator of the level of effectiveness of the first cue in the target database, electronically creates a second message, electronically creates a second cue for incorporation into the second message, the second cue being tailored to elicit an intended second response from the target based upon the collected target data and the indicator of the effectiveness of the first cue, electronically alters the second message by incorporating the second cue into the second message, electronically delivers the altered second message via the web to the target, determines an actual response by the target to the altered second message, such response indicating a level of effectiveness of the altered second message to elicit the intended second response from the target, utilizes the determined response as an indicator of the level of effectiveness of the second cue, stores the second indicator of the level of effectiveness of the second cue in the database, and utilizes the collected target data and the indicators of the levels of effectiveness of the first cue and the second cue when creating a subsequent cue for a subsequent message to be presented to the target.

### BRIEF DESCRIPTION OF THE DRAWINGS

For a more complete understanding of the disclosure, reference should be made to the following detailed description and accompanying drawings, wherein:

FIG. 1 is a block diagram illustrating a user utilizing a conventional web enabled device to access web pages via the internet, in accordance with the invention;

FIG. 2 is a flow-chart in accordance with one aspect of the invention;

FIG. 2 is a flow-chart in accordance with one aspect of the invention;

FIG. 3 is a flow-chart in accordance with another aspect of the invention;

FIG. 4 is a flow-chart in accordance with another aspect of the invention;

FIG. 5 is a flow-chart in accordance with another aspect of the invention;

FIG. 6 is a flow-chart in accordance with another aspect of the invention; and

FIG. 7 is a flow-chart in accordance with another aspect of the invention;

### DESCRIPTION OF THE PREFERRED EMBODIMENT

It is to be understood that this disclosure is not intended to limit the invention to any particular form described, but to the contrary, the invention is intended to include all modifications, alternatives and equivalents falling within the spirit and scope of the invention as defined by the appended claims.

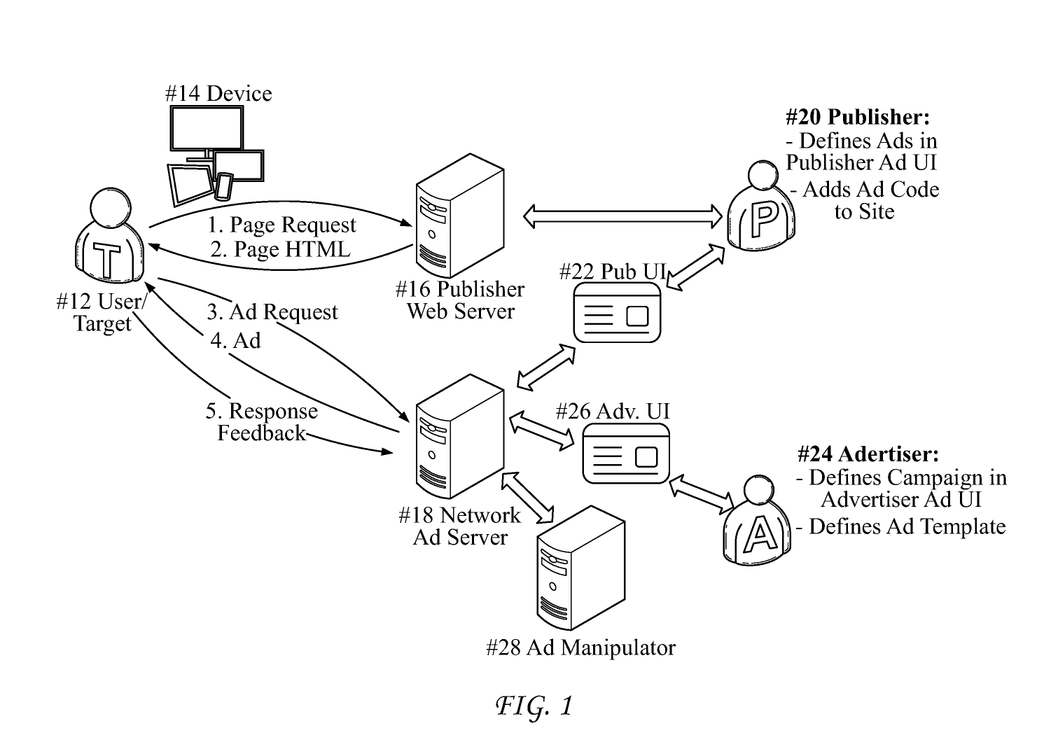

In accordance with the present invention, a system 10 permitting a user 12 to utilize a conventional web-enabled device 14 to access web pages, such as via the Internet, is illustrated in FIG. 1. The web-enabled device 14 may be any such device, which permits the user 12 to access conventional web pages, such as a conventional computer, tablet, smart phone, or the like.

As is conventionally known, the user 12 may utilize the web-enabled device 14 via a conventional web-browser to issue a page request to a publisher web server 16. The publisher web server 16 may respond, sending a page, such as in HTML format, with an advertisement space for an advertisement back to, and to be displayed on, the web enabled device 14. The page sent to the web-enabled device 14 may include instructions to request a particular advertisement to be a part of (i.e., incorporated into) the advertisement space of the displayed webpage. The request for this advertisement may be conventional and may include the specific web-address of a desired network ad server 18, and the particular advertisement located on the network ad server 18, as is well known. Thus the web-enabled device 14 may send the ad request to the network ad server 18. The network ad server 18 may then send the requested advertisement back to the web-enabled device 14 to be displayed, embedded in the requested webpage.

The system 10 may also include a publisher 20 which may perform such functions as defining ads in a publisher ad user interface 22 as well as adding advertising code to a website.

The system 10 may further include ad advertiser 24 for which may define ad campaigns in an advertiser user interface 26 as well as for defining and/or uploading creative input.

In accordance with the present invention, the system 10 may still further include a creative optimizer 28, which may be part of, and wok in conjunction with, the network ad server 18. As discussed below, the creative optimizer 28 may analyze known information about a target, and may respond to responses from the target to progressively modify cues embedded in advertising presented to the target until a maximized ad response is achieved.

As discussed above, creation of a targeted ad may begin with use of known information about the targeted user, otherwise referred to as Data Gathering. This information, and any updates thereto, may be stored on a conventional data storage device (not shown) located on the creative optimizer 28 or accessible by the creative optimizer 28.

Data Gathering Data about a target may come from six primary sources, but may be supplemented with additional sources. These methods of data gathering are conventional.

With the Ad Request—Data about a target can be passed in as a parameter with, or as part of, an ad request. Standard information received as part of an HTTP request may be used. For example, a target's IP address may be used to determine the target's likely location, and then may be cross-referenced with publicly available demographic data like average income levels and ethnic makeup of an area. This may also include any value information the publisher (or owner of the ad space) knows and shares. For instance, ads appearing on a pet store web site or mobile app where a target has registered his/her pet may pass a value representing that the target owns two Dalmatian puppies. This data exchange could take place in advance as well, passing only a unique identifying value which is then associated with the target's previously exchanged information.

Previous Encounters—Data collected and stored on the data storage device may be cumulative. Either by association with a conventional cookie, or by matching browser finger print and IP blocks or other mostly unique data points, most targets can be tracked each time an ad request is made. As subsequent requests are made, the information retained about a target may be stored and added to the previously stored data. For instance, the first time a target is presented with an ad, only demographic data where they are located may be available. In a future ad request, it may be passed that the target is a 42 year-old male. And in yet another request the target's name and that they searched for “Fairless High School Alum” may be sent. At this point it is known that the target is likely/possibly a 42 year-old male named John Smith that probably went to Fairless High School. So on and so forth the data may be gathered.

Real Time Bidding (RTB) process & Cookie Matching—This is a conventional industry method of buying Internet and mobile advertising space. As part of the initial information passed in the process is data such as latitude, longitude, gender, age, publisher vertical, information about the application or web site, content vertical and content near where ad will be presented, and a unique user ID for that target. Example information about Google's ad exchange and RTB may be found at https://developers.google.com/ad-exchange/rtb/. Information about how additional data may be matched as part of this process using cookie matching is conventional and may be found at https://developers.google.com/ad-exchange/rtb/cookie-guide.

Internal Database—One utilizing the present invention may have access to existing data associated about a target and may use that information as well. For instance, Google, Facebook, LinkedIn, Microsoft, etc. all have already existing databases with details about their users and others, i.e., potential advertising targets.

3rd Party Data Vendors—Once enough information about a target is known to uniquely identify the target, commercial services such as LexisNexis or Acxion may be used to retrieve further data about a target. Agreements with data partners may also be used to facilitate gathering additional details about a target that may be used to narrow down what will be most effective when presented to them.

Public Information From the Internet—Once certain details are known about a target, such as name and location, a separate process may be used that searches online for matching details and further supplements the local data set with information people have made public.

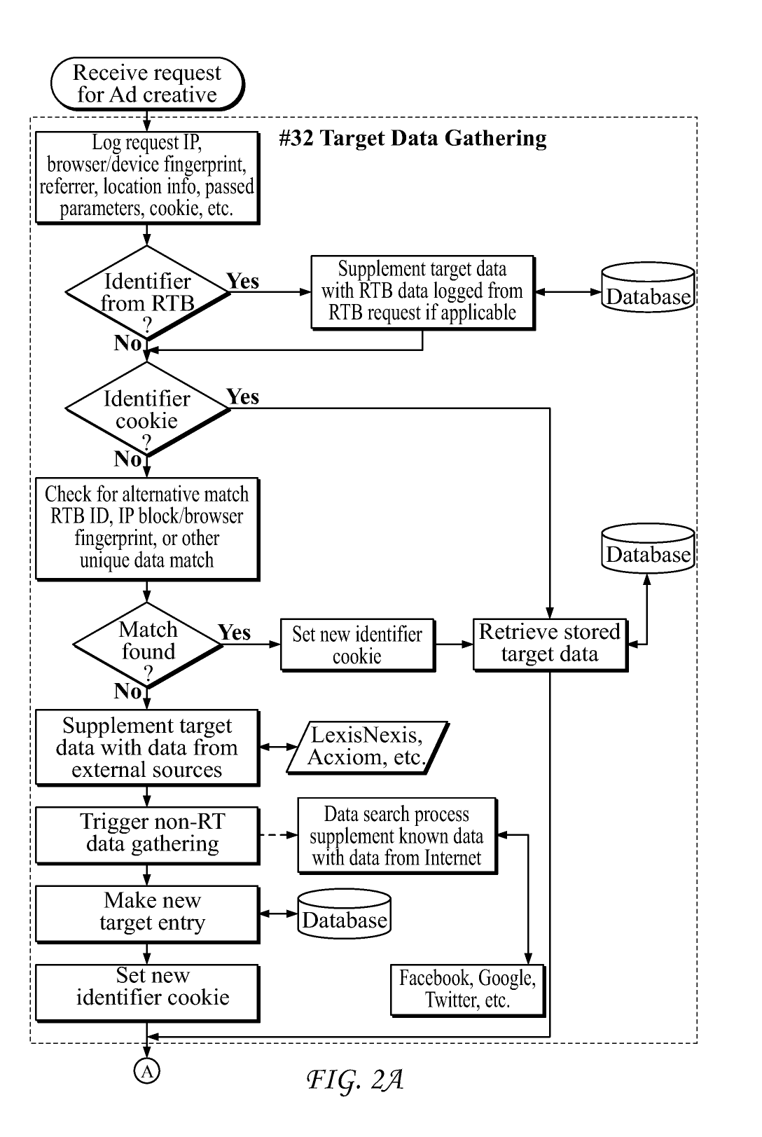

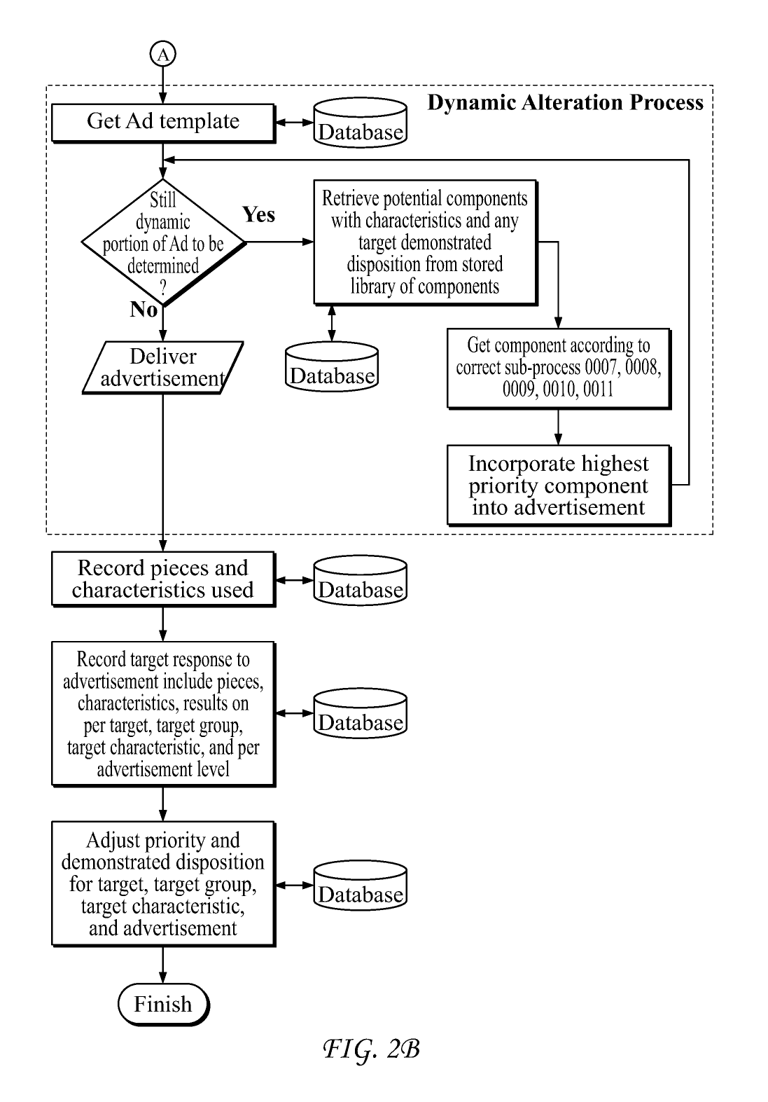

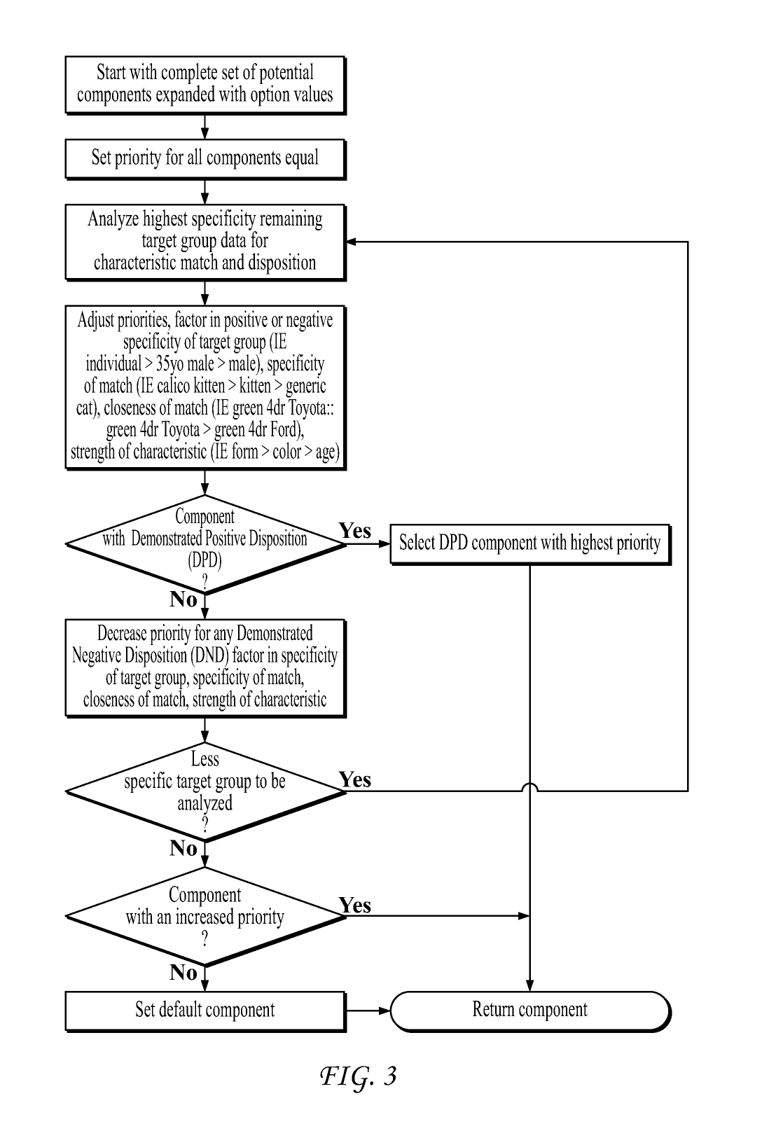

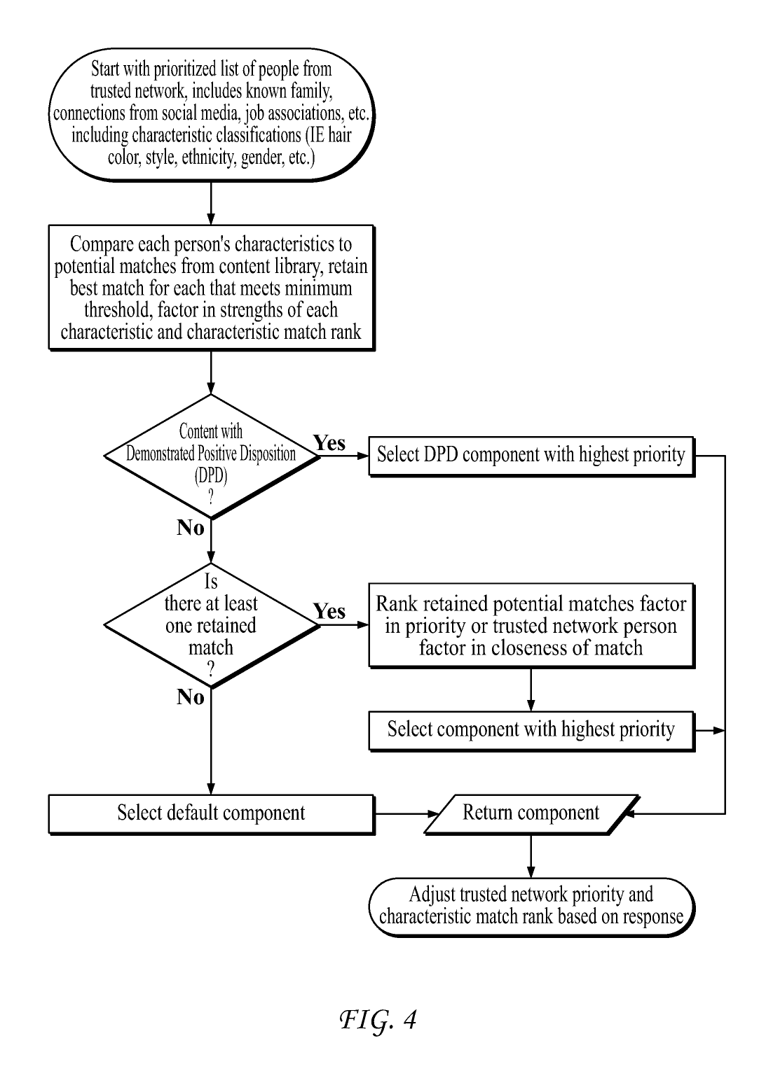

FIG. 2 is a flow diagram in accordance with the present invention. The following is a general description of the process as it applies to each ad request.

A request for an advertisement may be received in a step 30. This may be from code posted by a publisher or ad space owner (ex. JavaScript on a web site), directly from the publisher (ex. server to server integration with a video channel and video content), the result of a real time bidding process, or any other method designating that an advertisement is needed. The request may be accompanied by information about the target of the advertisement. See the Data Gathering description above for more detail.

In a step 32, data is collected regarding a target that has caused an ad request to be submitted. The request and associated information is logged into the database. This includes details like IP address, location information, referrer, cookies, passed parameters, etc. Data may be logged in a manner to allow retrieval for use in billing, analysis, and to supplement known data about the target

If there is an identifier from a RTB, it may be used to retrieve additional data from the database and add it to the request for use to help determine how an advertisement will be modified. Similarly, if there is an Identifier cookie or other unique data id passed with the request, it is used to retrieve that additional data from the database and add it to the request for use to help determine how an advertisement will be modified.

When no unique identifier for our database is present, alternative unique matches are checked, such as the RTB unique user ID or IP Block and browser fingerprint. If a match is found, a new identifier cookie is set if applicable, and the match is used to retrieve that additional data from the database and add it to the request for use to help determine how an advertisement will be modified.

When no unique identifier is present and no unique data matches can be found in the database, request data is supplemented with data from 3rd parties and or local databases used for cross referencing.

A non-real time data gathering process is also triggered. This is a separate process that may take place at a different time, which performs additional searching, and data gathering on the target for future use.

An entry for the new target may be created in the database and all known data associated with the target may be logged. A new identifier cookie may be set if applicable.

The next step for all ad requests is to retrieve the template for the advertisement to be served. The template is previously created and specifies parameters like size ranges, areas that are able to be altered and how those areas are able to be modified, default components, and any other information associated with the ad needed to make the alterations.

Each dynamic portion of the advertisement designated in the as template may then be processed in the order specified in the ad template, as the results of one dynamic portion may affect potential components for another dynamic portion. For each dynamic portion, the set of potential components and associated data is retrieved and processed with the corresponding sub-process for the strategy to be used for that portion. See individual processes for more detail on each strategy. The highest priority component returned may then be incorporated into the advertisement. This may then be accomplished with standard media manipulation software appropriate to the medium, such as ImageMagic for image-based ads. This process may be repeated until each dynamic portion has been processed and incorporated into the ad.

The resulting advertisement may then be returned to the requester for delivery to the target. It may be delivered directly to the target, as in the case of a web displayed ad, or stored for later delivery, as in the case of a video commercial, which takes more computing time.

The final advertisement, components used, associated characteristics, and related data are stored in the database. How a target responds to the advertisement once it is delivered may also be recorded. This information may also be used to update weights and priorities throughout the system to improve future performance. Refer to the individual sub-processes for details.

According to an aspect of the invention, one or more cues, particular to a specific target, may be dynamically added to, or otherwise incorporated into, advertising directed to the particular target, based upon information known by the advertising provider about the specific target, to tailor or otherwise customize the specific advertisement delivered to the specific target.

For example, a conventional advertisement requesting donations to the ASPCA may include a cue in the form of a picture of what might be considered a cute animal, to elicit an intended response in the form of a donation. However if it is known that a particular target likes dogs, the cue may be dynamically changed to specifically be a picture of a dog. And if it is also known that the particular dog the target likes is a beagle, the cue may be dynamically changed to be a picture of a beagle. And so on. Thus the nature of the cue may be altered based upon the scope and extent of information known about the particular target. Additionally the nature of the cue may continue to be dynamically altered, as additional information becomes known about the specific target. Further the nature of the cue may be altered in real time, as additional information about the specific target becomes known, without the target being aware of the progressive alterations.

According to another aspect of the invention, dynamic altering of advertising cues may be applied to Internet advertising, utilizing various sources of information available about users on the Internet, such a information stored on cookies on the user's computer, the user's social media, the user's trusted network, the user's prior purchases or browsing habits, or the like.

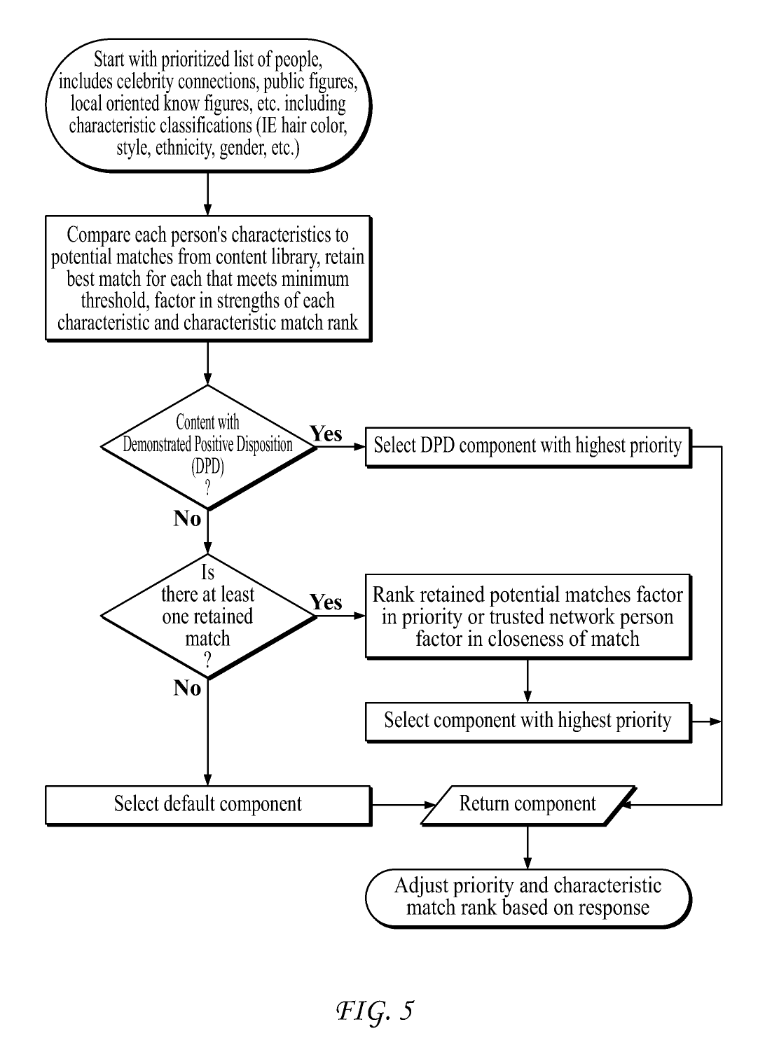

It is contemplated a cue may be altered by using a subject presenting similar cues to people from the target's trusted network. See FIG. 5 for the following.

Everyone has a trusted network, a group of people that they are familiar with, trust or listen to. This may include family members or parents, supervisor or high ranked people at work, or regular friends, and even one's self. By mimicking the cues that an advertisement target's brain has learned to associate with people from their trusted network, an advertisement is more likely to get past the targets attention filter and may benefit from the emotional response that the target associates with the specific person mimicked. Similar to how someone might recognize a doppelganger of their friend in a crowd. Furthermore, the cues presented and the people from the trusted network do not have to be identical, just having key similarities that the target's brain uses as a trigger is enough.

For example, an advertisement for car insurance might have an image of a spokesman standing next to a car and some exclamation of saving money. When the advertisement is displayed to Joe, rather than having a spokesman presenting with a generically trustworthy persona, the advertisement would be altered, using an image of a person that has similar visual cues to Joe's father. When it displayed to Sally, the spokesman used may have similar visual cues as Sally's best friend.

A content library of suitable components (images of people for image ads, voice overs for audio ads, etc.) for use in an advertisement should be predetermined, as part of the ad definition. Suitability meaning “acceptable for use in the advertisement; pose, correct emotion pictured, etc. ad determined by the advertiser”. These may come from a generic content library, or be specifically created for a particular ad. Associated with each component is a set of characteristics, which is previously determined and stored with the components. These characteristics include but are not limited to details such as hair color, age, race and other facial, body, voice features, or calculated values used in feature recognition algorithms. These features can be identified manually, using SIFT, Eigenface, or other feature recognition algorithm. Characteristics are also associated with a value for strength, such that race may be represented as more important than height when evaluating similarities. These strengths will be adjusted over time based on performance so more effective characteristics are given more weight and less effective ones decrease in value. When a person is added to the database as being in a target's trusted network (refer to the section above about gathering info), images of them are evaluated and stored for the same characteristics as are used in the content library. The trusted network associations are also assigned a value for priority, such that a parent or close friend is ranked higher than the average work associate. These priorities will be adjusted over time based on performance so that more effective influencers increase in priority and less effective ones rank lower. The trusted network associations are also assigned a minimum threshold value such that people with a distinctive look may require a closer match than a person without distinctive features. These values will be adjusted over time based on performance.

The process specific to adding cues similar to someone from a target's trusted network may begin with taking the complete list of people determined to be in a target's trusted network. Beginning with the one with the highest assigned priority, each suitable potential component may be compared using the characteristics previously assigned along with the strengths assigned to the characteristics, and a value for closeness of match is determined such that more characteristics and matches of higher strengthen characteristics constitute a closer match. Matches must meet a minimum threshold value for closeness of match to be considered a match. The minimum threshold may be adjusted over time based on performance. The best match for each person and meeting the minimum threshold may be retained in the list as a potential component for use in the ad.

If no components remain in the list, either a default component may be used or a component may be selected using the process discussed above. If there is a component remaining in the list to which the target has previously demonstrated a positive response (Demonstrated Positive Disposition, DPD), the DPD component with the strongest previous response and highest priority in the person's network is used in altering the advertisement. Given no DPD, the component with the closest match to the highest priority trusted person should be used in the advertisement.

Depending on whether a target responds to the advertisement, the priority of the trusted person, their minimum match threshold, and other values may be adjusted as feedback to improve performance of the system over time.

It is further contemplated that a cue may be altered by using a subject, which presents similar cues to people, which may elicit a response from the target.

Everyone has one or more particular people that the thought of may elicit a response. This may include celebrities, politicians, locally known personalities, or anyone that elicits a response. This response could be any emotional response, positive or negative. By mimicking the cues that an advertisement target's brain has learned to associate with people from their trusted network, an advertisement may be more likely to get past the targets attention filter and may benefit from the emotional response that the target associates with the specific person mimicked. Furthermore, the cues presented and the person of meaning to the target may not have to be identical, just having key similarities that the target's brain uses as a trigger is enough.

For example, an advertisement for car insurance might have an image of a spokesman standing next to a car and some exclamation of saving money. When the advertisement is displayed to Joe, rather than having a spokesman presenting with a generically trustworthy persona, the advertisement would be altered, using an image of a person that has similar visual cues to Joe's favorite rock star. When it is displayed to Sally, the spokesman used may have similar visual cues Sally's local mayor.

The sub-process is similar to that for matching visual cues to someone from a trusted network, with the exception that rather than using a target's trusted network, it may use a list of people that the target may be familiar with and respond to. This list is compiled using the data gathering methods describe above. If the target is a group, rather than an individual, the spokesman presented may still be altered, changing race, age, etc. to appeal to most narrow range of information known about the target.

It is further contemplated that a cue may be altered by using a likeness to objects, which may elicit a response from the target.

Similar to how the cues for people can be mimicked, one may also leverage the response associated with the cues of other things as well. This may include, but isn't limited to, animals, cars, foods (targets specific toppings shown on a pizza or preferred combination of sides), places (recognizable backgrounds or skylines of place a target grew up, lives, or visited, or likes), experiences (favored activity like riding roller coaster vs camping vs baseball game). For example, if the target has a black and white Dalmatian puppy, those cues can be mimicked in the advertisement. It may be directly related, such as by an ad for dog food, or indirectly, as in the case of a travel advertisement picturing a person on a beach with a dog presenting similar cues. The object associated with the cues also may not need to be current. For instance the cues may mimic a childhood pet. Taking the example from sub-process above, the car pictured may be a visually reminding make, model, color of the targets current car or one they previously owned.

The sub-process of altering an object begins with taking the complete list of potential components from the library as defined by the advertisement template in the general process described above. Any component that has options that can be expanded, such as a car that can be included in a variety of colors, may be included separately with each combination of options. Initially all the same, a temporary value for the priority of each potential component is set

Next, starting with the most specifically defined target group (i.e., uniquely identified individual>gender, race, age match>age, zip code match>etc.), known preferences may be used to adjust the temporary priorities. A favorable characteristic match increases a potential components priority while an unfavorable one decreases the potential's priority. Factors included are how specific the target group is defined (with a more specifically defined group having more pull than more general groups), how specific the matching object is (IE an adolescent calico kitten image is adjusted more than that of a generic cat), how close the match is (IE matching more characteristics to that favored by the defined target group is adjusted more), and strength of characteristics (IE form is more important than color, so it adjusts the priority more).

If there exists a component that has previously Demonstrated Positive Disposition with the currently being analyzed target group, it is selected. If there is more than one, then the one with the highest priority is selected, and the group analysis stops. If there isn't one, analysis continues.

If any components have previously Demonstrated Negative Disposition with the current target group, their priority is decreased, using the same factors as used to increase the priority.

This continues until either a component is selected, or there are no less specific target group definitions to be analyzed.

If there is at least one component with a higher priority than what it started with, the one with the highest temporary priority is selected. Otherwise, the default component defined with the ad template may be selected.

The selected component may be returned to the main process for incorporation into the advertisement.

It is further contemplated that a cue may be altered by inserting branding, which may elicit a response from the target.

Similar to how people associate a response to objects and people, they may also respond to brands and logos. This is distinct from forms of co-branding in that there does not need to be an association of the product, like “Pillsbury Brownies with Nestle Chocolate”, or Visa co-branding a Costco Card, the brand does not need to demonstrate endorsement or be related to the object of the advertisement, and it does not need to leverage the brands client base. This also differs from product placement in that items or brands are not being incorporated to receive exposure or to associate their use by a notable person in an ad, but rather to associate a response invoked by the brand with the advertisement.

For example, the video advertisement for a car dealer may have theme music from a targets favorite sports league incorporated, or an advertisement for KOA depicting people camping may be altered so that the people pictured are drinking the target's preferred brand of beverage.

The sub-process for incorporating branding into an advertisement is the same as with the above sub-process, incorporating objects.

It is further contemplated that cues may be generic cues, such as outfit or dress, race, color, voice, or the like.

Similar to people's responses to people, objects and brands, other cues can be altered to which the target is more likely to associate or respond. These cues may be things like color, for example altering a background color of the advertisement or the color of the vehicle in a car advertisement to match the target's favorite color. They may also be thing like how the person in the advertisement is dressed, since a business person may be more likely to respond to someone in a suit where others would be more responsive to someone in less formal attire.

The sub-process for incorporating branding into an advertisement is the same as with the above sub-process, incorporating objects.

The cues that targets have a predilection to may also be altered in the advertisement; separate from mimicking a specific person, object or brand. For instance, since Joe has demonstrated a better response to blond females pictured in an advertisement, a blond female image may be incorporated where an ad presented to Sally might incorporate images of children instead.

The sub-process for incorporating previously demonstrated dispositions is incorporated as a feedback mechanism for each sub-process, and is describe as part of the general process.

It is further contemplated that a cue may be altered to mimic cues to which the target has previously demonstrated a predisposition. It is further contemplated to provide a library of content and means for adjusting/preprocessing the content to determine cues it conveys. Target(s) data may be preprocessed and stored in a summarized form containing estimated weighting of effects of factors, cues, and cue groups (multiple cues associated with a person or object). An advertisement “template” with predetermined possible ways of altering cues may be selected. The advertisement may be altered in ways based on the template using image processing and the library of content. The advertisement may then be sent for display to the target either in real time or for a future time.

The cues that targets have a predilection to may also be altered in the advertisement; separate from mimicking a specific person, object or brand. For instance, since Joe has demonstrated a better response to blond females pictured in an advertisement, a blond female image may be incorporated where an ad presented to Sally might incorporate images of children instead.

The sub-process for incorporating previously demonstrated dispositions may be incorporated as a feedback mechanism for each sub-process.

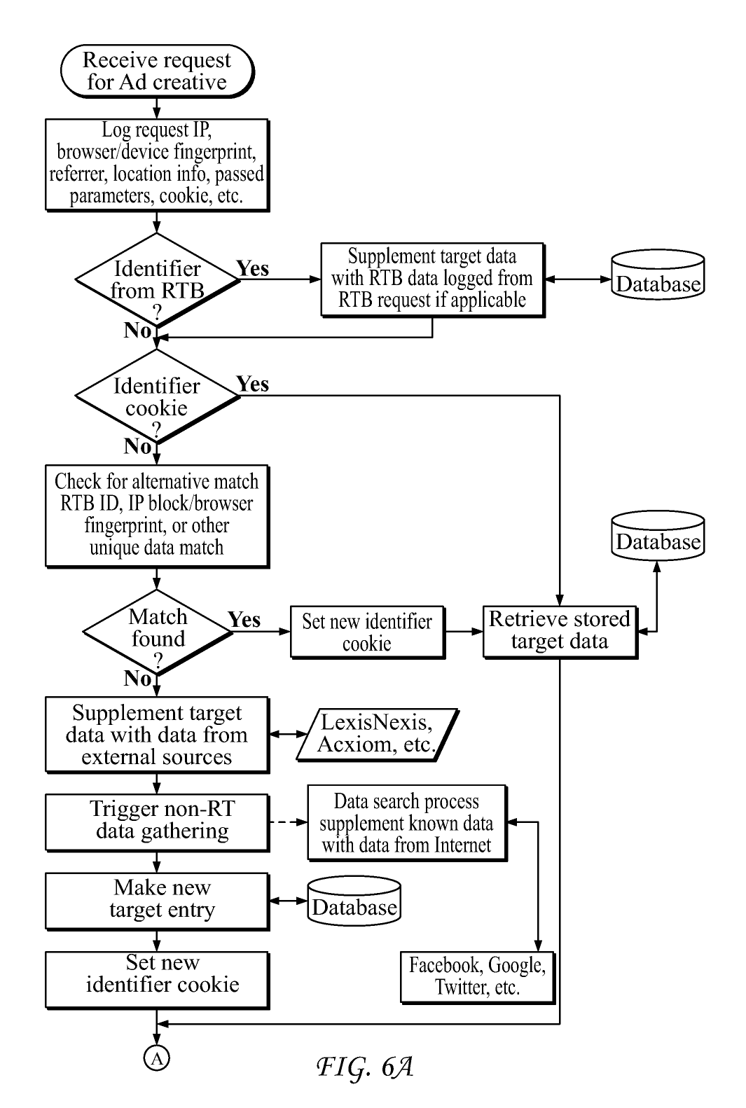

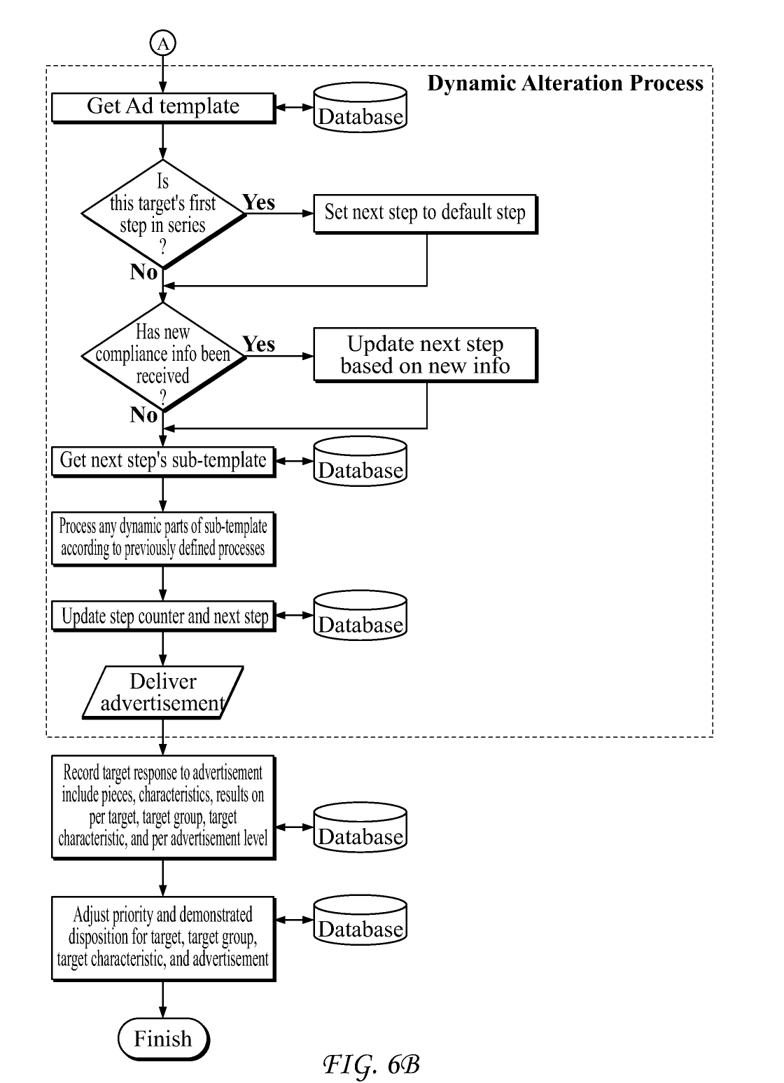

It is still further contemplated to present a series of ads to the same target and progressively change the ads to gradually to obtain greater compliance through progressive steps. See FIG. 6.

Step progression may be fixed as in number of times displayed or displayed for set amount of time, or varied based on reaction. For example once target complies with a step B, move to a step C. An example might be a series of ads where a first ad is conveying that a product is good, followed by ads for a free sample, followed by ads for a small purchase, followed by ads for a large purchase or greater commitment, followed by brand reinforcement ads.

The idea behind this process is that advertisements presented in a series may be more effective, either by breaking a large compliance steps into smaller pieces or by walking the target through a tailored path to completion. When and which the next step of the series is presented can be a set number or time frame, or varied based on the targets reaction, or a separate behavior or trigger. Furthermore, a series may progress both in a forward manner, or regress based on the triggers. Each individual target is presented with the next step in the path for them to maximize achievement of the goal of the advertisement.

This is best explained with several examples. Example one is a series of ads, which are pieces to a story, designed to heighten suspense and climax at the point of the advertisement. Each piece will be presented five times to each target before proceeding to the next ad. At any point in time, Joe may be presented with ad three while Sally is presented with ad eight, since she has progressed farther in the series.

Example two minimizes the cost and maximizes compliance for a non-profit attempting to have Joe donate. The series may begin by getting conveying that a target should like a Facebook page. Bidding for step one is kept minimal and sent to a wider audience than would normally be targeted. Ads for step two in the series would be presented only after the target has liked the page on Facebook and would convey joining the organization only. Higher bids would be used for step two since some compliance has been demonstrated already and the target is farther in the sales funnel. Once the target has joined, the ad series would progress to donating a small amount, and then to a larger amount.

Example three breaks a large compliance step, which is unlikely to be successful, into a series of small compliance steps more likely to be successful. Presenting Joe, belonging to Political Party X, an advertisement to vote for Party Z Candidate is unlikely to work. However, with our technology, beginning with an ad conveying “the Party X Candidate is not trustworthy”, followed by “Party X Candidate (insert point Joe disagrees with)”, followed by “Candidate Z (insert point Joe likes)”, followed by “Vote for Candidate Z” is more likely to be successful.

This may sound similar to, but is distinct from the current method of re-targeting which presents an advertisement to a group of people that previously visited a web site, or place of business and did not make a purchase.

The first portion of receiving a request for an ad and gathering data about the target is the same as previously described in the general process.

Once the ad template is retrieved, if it is the target's first time receiving an ad from the series or no Next Step has been defined for the target, the default step is used. This default may be varied based on information known about the target, as defined in the ad template. For instance, in the political ad example, a die hard Party X target may start at the most extreme step, while an unknown target falling within a specific zip code may enter the series in the middle.

If any new info about the target's compliance of behavior has been received it is used to update the Next Step. This can take place as a separate process updating target's next step as information is received, rather than just before the ad is processed for presentation. For instance, a target's next step might be updated at the time they clicked like the Facebook page or installed an application, or performs whatever triggers the series to progress.

Once what the Next Step will be is determined, it's sub-template is retrieved. If there are any dynamic portions defined in the sub template they are processed according to the previously defined procedures, creating the final version of the advertisement to be delivered to the target.

Any step counters and the Next Step intended for the target are updated based on what the current step being delivered is going to be. For instance, if a step calls for delivery of sub-template G five times to the target, the counter recording that the target was delivered this template would be incremented. If this was the 5th time, Next Step would be progressed to sub-template H.

The final advertisement version is then delivered to the target.

The remainder of the process, recording the response and updating priorities, is the same as the general process, previously described.

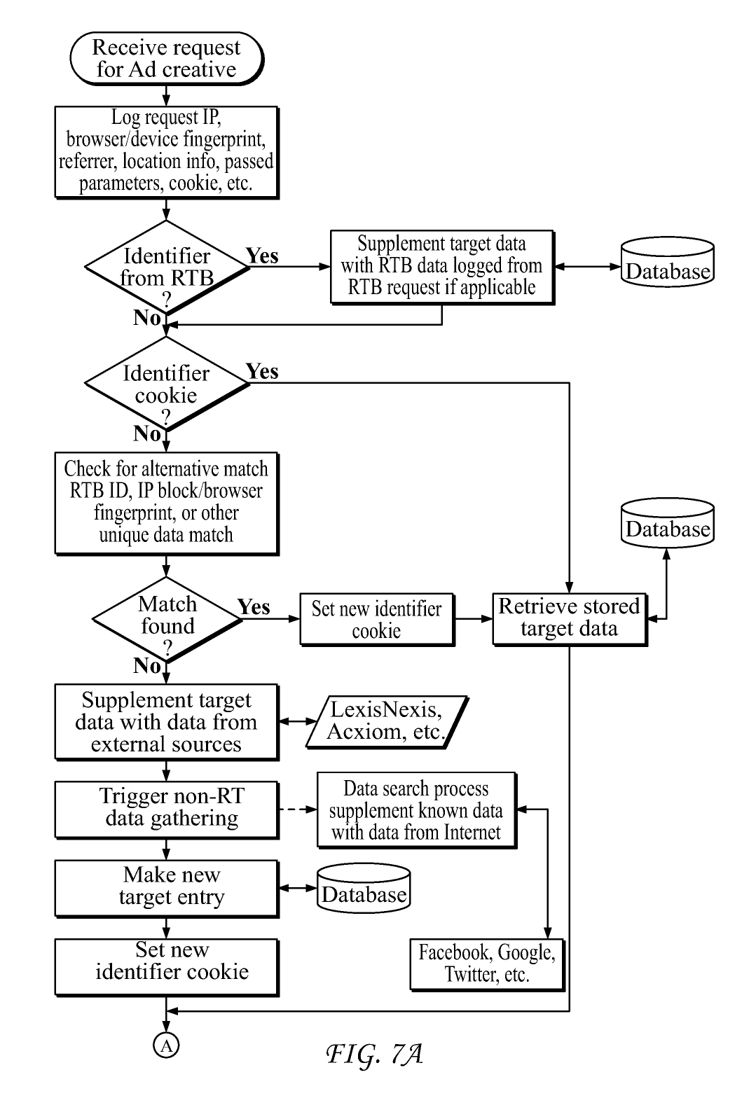

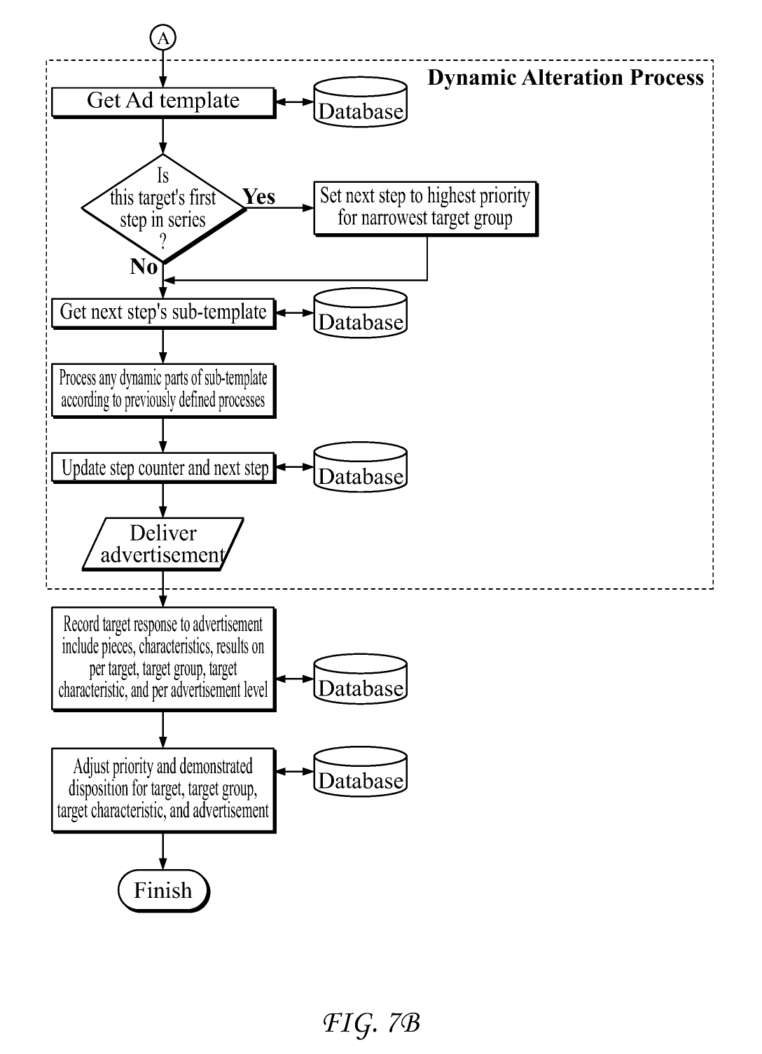

The series of ads could also be altered by response to a compliance tactic. See FIG. 7. For example, if the target does not initially respond to a positive Self-feeling compliance technique, it could progress to ads of negative Self-feeling, followed by positive Altercasting, negative Altercasting, Promise, Moral appeal, and the like, until compliance is obtained.

This process is very similar to the Advertisement Series described on process 0013, with a few key differences. First, the target would enter the series based on the type of compliance tactic they have previously shown a positive response to, or at the least aggressive technique if no information on the target or target group exists. A target group, rather than only an individual target can be used to determine at which tactic a target enters the series. Second, the ad series consists of ads presenting progressively stronger compliance tactics. These tactics include compliance or persuasion tactics such as positive Self-feeling compliance technique, negative Self-feeling, positive Alter-casting, negative Alter-casting, Promise, Moral appeal, etc. The series progresses until compliance is received, at which time the series is complete.

For example, Sally, having previously shown a favorable response to Positive Self-feeling ads, may be presented with an ad with messaging like “You will be happy if you donate to XYZ Charity. After five ad views and 2 weeks (simple trigger to proceed to next step), the next time Sally is shown the ad it's messaging would be “You will feel bad if you don't donate to XYZ Charity”. At the next stage for Sally was Altruism, since she previously showed poor response to positive and negative Alter-casting and they were skipped, so her new ad messaging would be “Donate to XYZ Charity, for the children.” Once Sally donates, the ad series ends.

This process can be applied in conjunction with the 0013 process above, so that each step in the main ad series is a smaller series of varying compliance tactics, progressing to the next step of the main series, while maintaining the compliance tactic which successfully gained compliance from the target. The reverse can also be applied, where a compliance tactic, such as Door-in-the-Face, may consist of a series of ads from the 0013 process that together perform the tactic.

The first portion of receiving a request for an ad and gathering data about the target is the same as previously described in the general process.

Once the ad template is retrieved, if it is the target's first time receiving an ad from the series or no Next Step has been defined for the target, the highest priority step for the narrowest known target group is selected, or if no information is known, the default defined in the ad template. For instance, if Sally has previously shown the highest response to Positive Self-feeling ads that will be the starting point. If the only information known is that the target is a male between 35 and 40 years, Positive Alter-casting might be the starting point.

Once what the Next Step will be is determined, its sub-template is retrieved. If there are any dynamic portions defined in the sub template they are processed according to the previously defined procedures, creating the final version of the advertisement to be delivered to the target.

Any step counters and the Next Step intended for the target are updated based on what the current step being delivered is going to be. For instance, if a step calls for delivery of Positive Self-feeling sub-template five times to the target, the counter recording that the target was delivered this template would be incremented. If this were the 5th time, Next Step would be progressed to the next compliance tactic, skipping any with a previously demonstrated negative disposition for the target.

It is to be understood that this disclosure is not intended to limit the invention to any particular form described, but to the contrary, the invention is intended to include all modifications, alternatives and equivalents falling within the spirit and scope of the invention as defined by the appended claims.

We claim:

1. A method for enhancing content of a message to be presented to a target via a web accessible presentation device, the method comprising:
creating a first electronic message;
collecting electronic data regarding the target to create an electronic database of target data;
creating an electronic first cue for incorporation into the first message, the first cue being tailored to elicit an intended response from the target based upon the collected target data;
electronically altering the first message by incorporating the first cue into the first message;
electronically delivering the altered first message via the web to the target;
determining an actual response by the target to the altered first message, such response indicating a level of effectiveness of the altered first message to elicit the intended response from the target;
utilizing the determined actual response as a first indicator of the level of effectiveness of the first cue;
electronically storing the first indicator of the level of effectiveness of the first cue in the database; and
utilizing the collected target data and the stored indicator of the level of effectiveness of the first cue when creating subsequent cues for subsequent messages to be delivered to the target.

2. A method for enhancing content of message sequentially presented to a target via a web accessible presentation device, the method comprising:
creating a first electronic message;
collecting electronic data regarding the target to create an electronic database of target data;
creating an electronic first cue for incorporation into the first message, the first cue being tailored to elicit an intended response from the target based upon the collected target data;
electronically altering the first message by incorporating the first cue into the first message;
electronically delivering the altered first message via the web to the target;
determining an actual response by the target to the altered first message, such response indicating a level of effectiveness of the altered first message to elicit the intended response from the target;
utilizing the determined response as a first indicator of the level of effectiveness of the first cue;
electronically storing the first indicator of the level of effectiveness of the first cue in the target database electronically creating a second message;
electronically creating a second cue for incorporation into the second message, the second cue being tailored to elicit an intended second response from the target based upon the collected target data and the indicator of the effectiveness of the first cue;
electronically altering the second message by incorporating the second cue into the second message;
electronically delivering the altered second message via the web to the target;
determining an actual response by the target to the altered second message, such response indicating a level of effectiveness of the altered second message to elicit the intended second response from the target;
utilizing the determined response as an indicator of the level of effectiveness of the second cue;
storing the second indicator of the level of effectiveness of the second cue in the database; and
utilizing the collected target data and the indicators of the levels of effectiveness of the first cue and the second cue when creating a subsequent cue for a subsequent message to be presented to the target.

3. The method of claim 2 wherein the second message includes the first and the second cues.

4. The method of claim 2 wherein the message is created in response to a request to a network ad server.

5. The method of claim 2 wherein the electronic database of target data includes a database of individuals considered to be trusted by the target.

6. The method of claim 2 wherein the electronic database of target data includes a database of animals considered to be trusted by the target.

7. The method of claim 2 wherein the electronic database of target data includes a database of inanimate objects considered to be trusted by the target.

8. The method of claim 2 wherein the electronic database of target data includes a database of branded logos considered to be trusted by the target.

9. The method of claim 2 wherein the electronic database of target data includes a database of colors considered to be preferred by the target.

10. The method of claim 2 wherein the electronic database of target data includes a database of prior favorable cues.

11. A system for enhancing content of messages sequentially presented to a target via a web accessible presentation device, the system comprising:
a network ad server communicatively coupled to the web for creating a first electronic message;
a data storage device communicatively coupled to the network ad server;
collected electronic data regarding the target comprising an electronic database of target data, the target data being stored on the data storage device;
an electronic creative ad optimizer for creating an electronic first cue for incorporation into the first message, the first cue being tailored to elicit an intended response from the target based upon the collected electronic target data;
wherein the network ad server electronically alters the first message by incorporating the first cue into the first message, electronically delivers the altered first message via the web to the target, determines an actual response by the target to the altered first message, such response indicating a level of effectiveness of the altered first message to elicit the intended response from the target, utilizes the determined response as a first indicator of the level of effectiveness of the first cue; electronically stores the first indicator of the level of effectiveness of the first cue in the target database, electronically creates a second message, electronically creates a second cue for incorporation into the second message, the second cue being tailored to elicit an intended second response from the target based upon the collected target data and the indicator of the effectiveness of the first cue, electronically alters the second message by incorporating the second cue into the second message, electronically delivers the altered second message via the web to the target, determines an actual response by the target to the altered second message, such response indicating a level of effectiveness of the altered second message to elicit the intended second response from the target, utilizes the determined response as an indicator of the level of effectiveness of the second cue, stores the second indicator of the level of effectiveness of the second cue in the database, and utilizes the collected target data and the indicators of the levels of effectiveness of the first cue and the second cue when creating a subsequent cue for a subsequent message to be presented to the target.

12. The system of claim 11 wherein the second message includes the first and the second cues.

13. The system of claim 11 wherein the message is created in response to a request to a network ad server.

14. The system of claim 11 wherein the electronic database of target data includes a database of individuals considered to be trusted by the target.

15. The system of claim 11 wherein the electronic database of target data includes a database of animals considered to be trusted by the target.

16. The system of claim 11 wherein the electronic database of target data includes a database of inanimate objects considered to be trusted by the target.

17. The system of claim 11 wherein the electronic database of target data includes a database of branded logos considered to be trusted by the target.

18. The system of claim 11 wherein the electronic database of target data includes a database of colors considered to be preferred by the target.

19. The system of claim 11 wherein the electronic database of target data includes a database of prior favorable cues.
